(19) United States
(12) Patent Application Publication
(10) Pub. No.: US 2026/0332934 A1
(43) Pub. Date: Oct. 22, 2026

(54) HEADBAND STRUCTURE

(71) Applicant: Merry Electronics(Shenzhen) Co., Ltd., ShenZhen (CN)

(72) Inventors: Ching Hsiung Lin, Taichung (TW); Yung-Tsung Hsu, Taichung (TW)

(73) Assignee: Merry Electronics(Shenzhen) Co., Ltd., ShenZhen (CN)

(21) Appl. No.: 19/199,366

(22) Filed: May 5, 2025

(30) Foreign Application Priority Data
Apr. 16, 2025 (TW) 114114289

(51) Int. Cl. H04R 1/10

(52) U.S. Cl. CPC H04R 1/105; H04R 1/1058; H04R 2201/105

(57) ABSTRACT

A headband structure includes an upper headband, two sliding structures, two fixing assemblies, and a lower headband. The upper headband includes first and second sides opposite to each other and has two sliding slots penetrating from first side to second side. Sliding structures are slidably disposed inside sliding slots respectively. A first gap is between sliding structure and first side, and a second gap is between sliding structure and second side. Fixing assemblies are detachably connected to corresponding two sliding structures and located near second side. The lower headband includes third and fourth sides opposite to each other. Fixing assemblies are disposed on the third side, and the third side is toward second side. Part of the second side of the upper headband and the fourth side of the lower headband form a wearing segment. When sliding structures slide with respect to upper headband, length of wearing segment is changed.

### CROSS-REFERENCE TO RELATED APPLICATION

This application claims the priority benefit of Taiwan application serial no. 114114289, filed on Apr.16, 2025. The entirety of the above-mentioned patent application is hereby incorporated by reference herein and made a part of this specification.

### BACKGROUND

### Technical Field

The disclosure relates to a headband structure, and particularly relates to a headband structure that may adjust a wearing length.

### Related Art

Currently, the headband structure of headphones on the market is formed by an upper headband with sliding rails and a lower headband that may slide on the sliding rails. Users may adjust the wearing length of the headband structure by sliding the lower headband with respect to the upper headband. However, during the process of adjusting the wearing length, the sliding rails of the upper headband create friction on the surface of the lower headband and leave scratches, causing poor appearance of the headband structure. Therefore, how to avoid friction traces on the appearance of the headband structure to maintain a good appearance is an issue that this field is committed to exploring.

### SUMMARY

The disclosure provides a headband structure, which may avoid friction traces on the appearance and may have a good appearance.

The headband structure of the disclosure includes an upper headband, two sliding structures, two fixing assemblies, and a lower headband. The upper headband includes a first side and a second side opposite to each other and has two sliding slots penetrating from the first side to the second side. The two sliding structures are slidably disposed inside the two sliding slots respectively, in which there is a first gap between each sliding structure and the first side, and there is a second gap between each sliding structure and the second side. The two fixing assemblies are detachably connected to the corresponding two sliding structures and located near the second side. The lower headband includes a third side and a fourth side opposite to each other, in which the two fixing assemblies are disposed on the third side and the third side is toward the second side, in which part of the second side of the upper headband and the fourth side of the lower headband form a wearing segment. When the two sliding structures slide with respect to the upper headband, a length of the wearing segment is changed.

In an embodiment of the disclosure, the upper headband includes a first housing, a second housing, and two sliding covers, the first housing is located at the first side, the second housing is located at the second side, the two sliding covers are connected to the first housing, located between the first housing and the second housing, and corresponding to the two sliding slots respectively, each sliding structure includes an abutting assembly and a connection assembly, the abutting assembly abuts against the connection assembly, a portion of the abutting assembly is slidably located between the first housing and the corresponding two sliding covers, and the connection assembly is slidably disposed on the second housing.

In an embodiment of the disclosure, the abutting assembly includes an abutting member and a first fixing member connected to the abutting member, a sliding portion of the abutting member is slidably located between the first housing and the corresponding two sliding covers, and the two sliding covers are located between the sliding portion and the first fixing member.

In an embodiment of the disclosure, the connection assembly includes a second fixing member and a connection member, the second fixing member is located between the abutting assembly and the connection member, the second housing is located between the second fixing member and the connection member, and the abutting assembly is connected to the second fixing member and the connection member.

In an embodiment of the disclosure, there is a second gap between the connection member and the second side.

In an embodiment of the disclosure, the second fixing member further includes a stopper portion, and the stopper portion surrounds the abutting assembly.

In an embodiment of the disclosure, each fixing assembly includes a fixing base and a base body disposed in the fixing base, and the two fixing assemblies are detachably connected to the corresponding connection assemblies respectively.

In an embodiment of the disclosure, each fixing assembly further includes a magnetic member disposed in the base body, the material of a connection member of the connection assembly is metal, and the two sliding structures are adapted to be connected to the corresponding two fixing assemblies through magnetic attraction between the connection member and the magnetic member.

In an embodiment of the disclosure, the base body has at least one engagement groove, the connection member includes at least one positioning portion, and the at least one positioning portion is adapted to reach into the at least one engagement groove, so that the connection member is connected to the base body.

In an embodiment of the disclosure, the abutting assembly has an abutting portion, the connection assembly has a groove, and the abutting portion abuts against the groove.

In an embodiment of the disclosure, the first housing includes a metal housing and a plastic housing, the plastic housing is located between the metal housing and the sliding cover, and the material of the sliding cover is plastic and is adapted to be fixed to the plastic housing by heat fusion.

In an embodiment of the disclosure, the abutting assembly includes a decorative cover, and there is a first gap between the decorative cover and the first side.

Based on the above, the headband structure of the disclosure includes the upper headband, the sliding structures, the fixing assemblies, and the lower headband. The sliding structure may slide with respect to the upper headband, and the lower headband is connected to the upper headband through the sliding structure and the fixing assembly. The user may adjust the relative position of the upper headband and the lower headband through the sliding structure, thereby adjusting the wearing length of the headband structure. Since the sliding structure has the first gap and the second gap between the first side and between the second side of the upper headband respectively, when the sliding structure slides on the upper headband, the sliding structure does not produce scratches on the surface of the upper headband, thereby ensuring that the headband structure has a good appearance.

### BRIEF DESCRIPTION OF THE DRAWINGS

FIG. 1 is a schematic view of a headband structure according to an embodiment of the disclosure.

FIG. 2 is a front view of the headband structure in FIG. 1.

FIG. 3 is an enlarged schematic view of a region A in FIG. 2.

FIG. 4 is an exploded view of the headband structure in FIG. 3.

FIG. 5 is a cross-sectional view of the headband structure in FIG. 3.

FIG. 6 is a cross-sectional view of the headband structure in FIG. 3 along a line B-B. FIG. 7 is a schematic view of an abutting member in FIG. 4.

FIG. 8 is a schematic view of a second fixing member in FIG. 4.

FIG. 9 is a schematic view of a connection member in FIG. 4.

FIG. 10 is a schematic view of a base body in FIG. 4.

FIG. 11 illustrates an abutting assembly disposed in a first housing, a connection assembly disposed in a second housing, and a fixing assembly disposed in a lower headband in FIG. 5.

FIG. 12 illustrates the abutting assembly disposed in the first housing, the connection assembly disposed in the second housing, and the fixing assembly disposed in the lower headband in FIG. 6.

### DESCRIPTION OF THE EMBODIMENTS

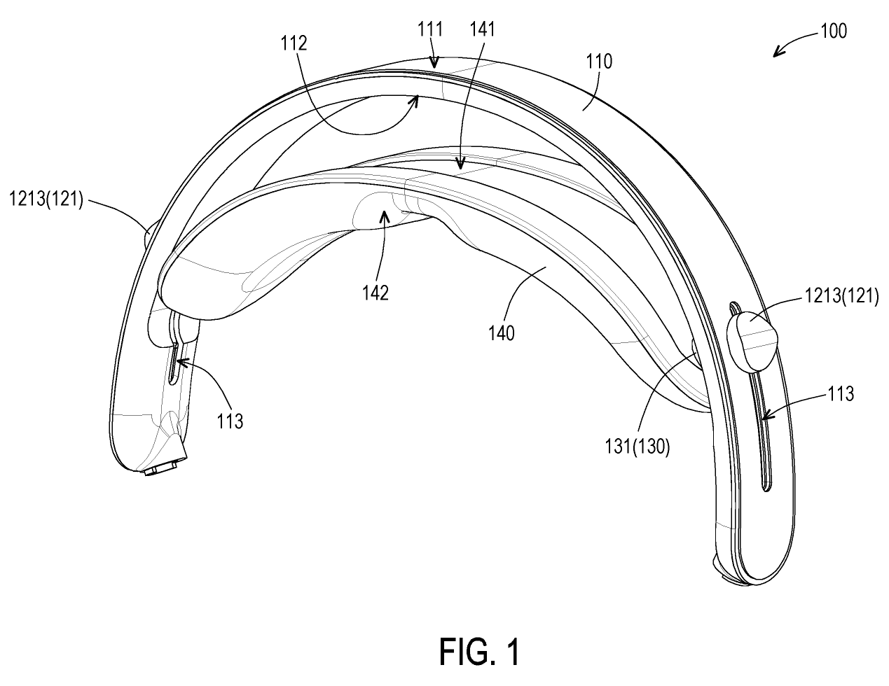

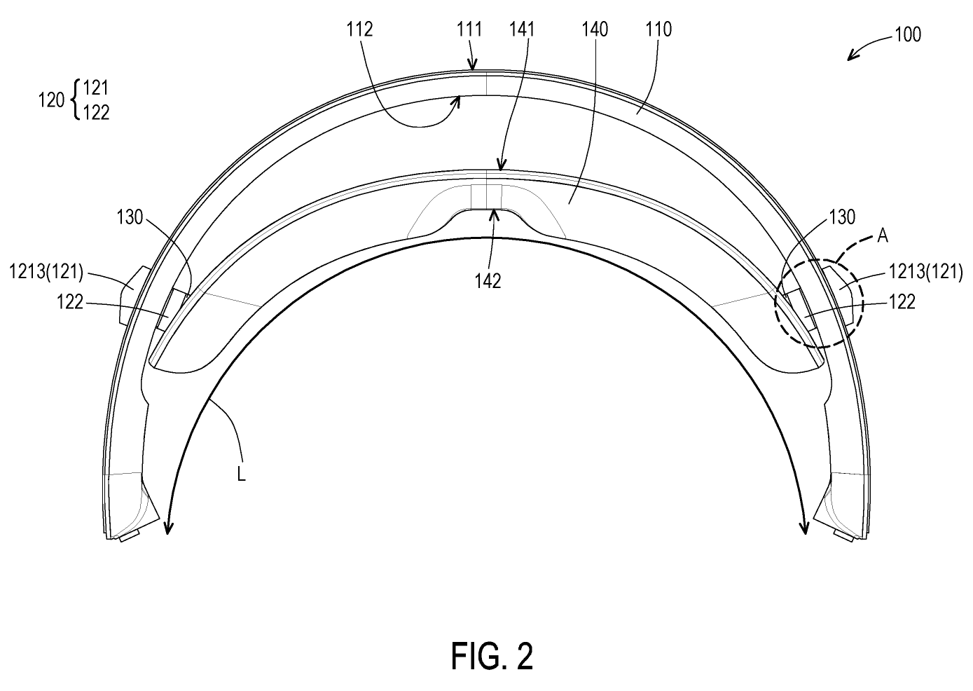

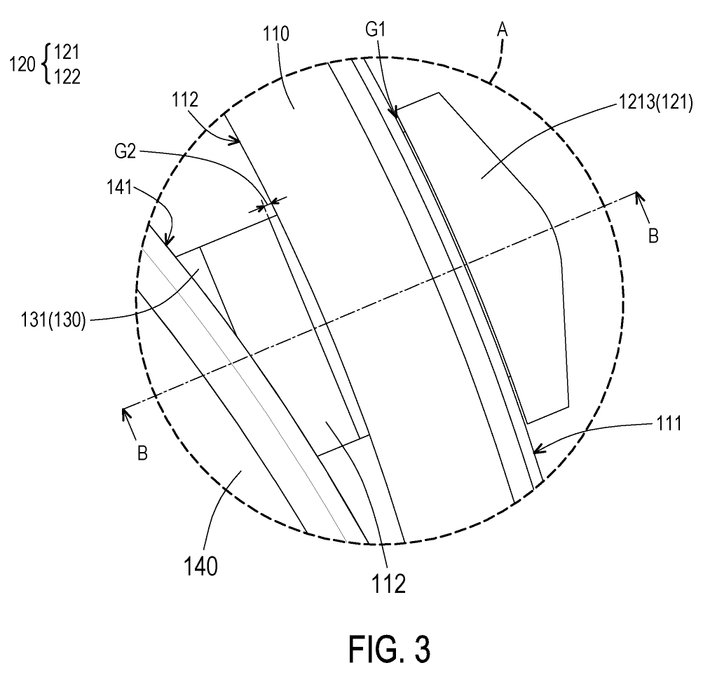

FIG. 1 is a schematic view of a headband structure according to an embodiment of the disclosure. FIG. 2 is a front view of the headband structure in FIG. 1. FIG. 3 is an enlarged schematic view of a region A in FIG. 2. Referring to FIGS. 1 -3, a headband structure 100 of this embodiment is, for example, a headband of a headphone. The headband structure 100 includes an upper headband 110, two sliding structures 120, two fixing assemblies 130, and a lower headband 140.

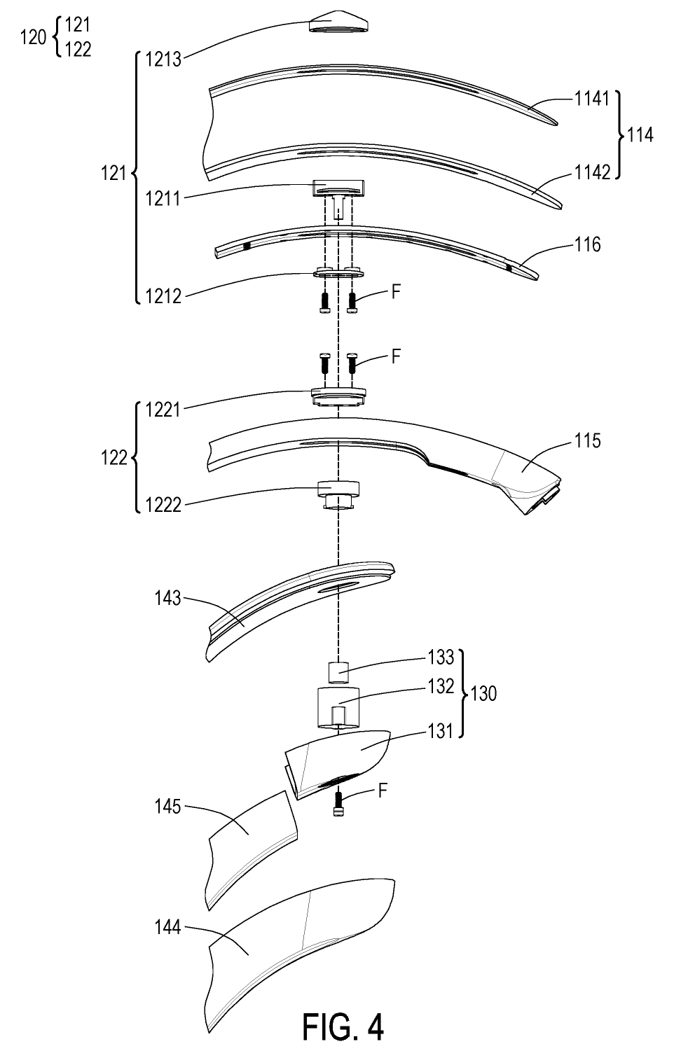

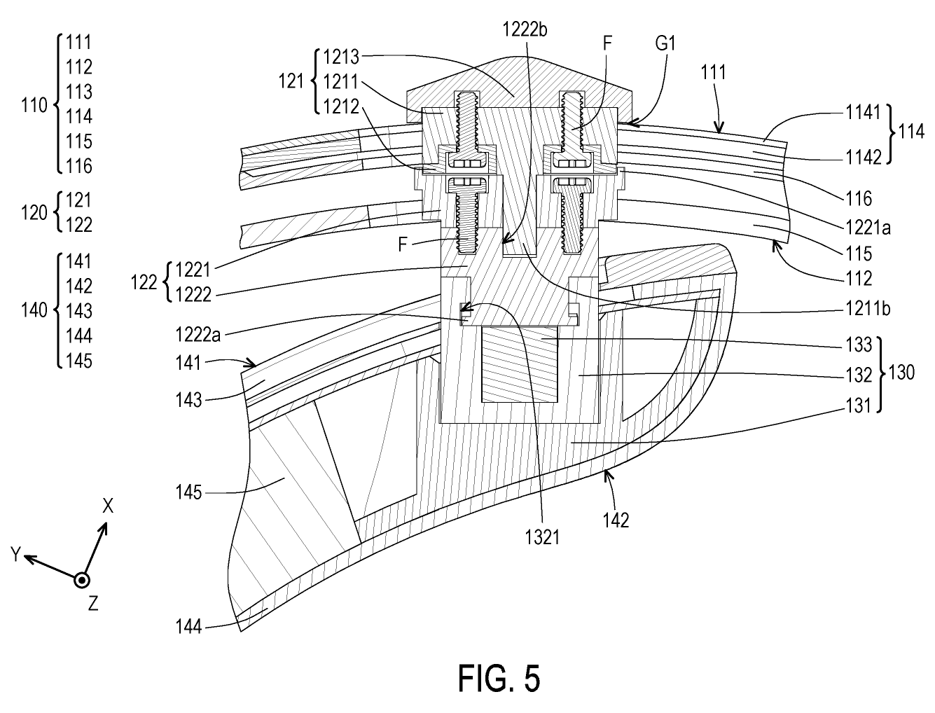

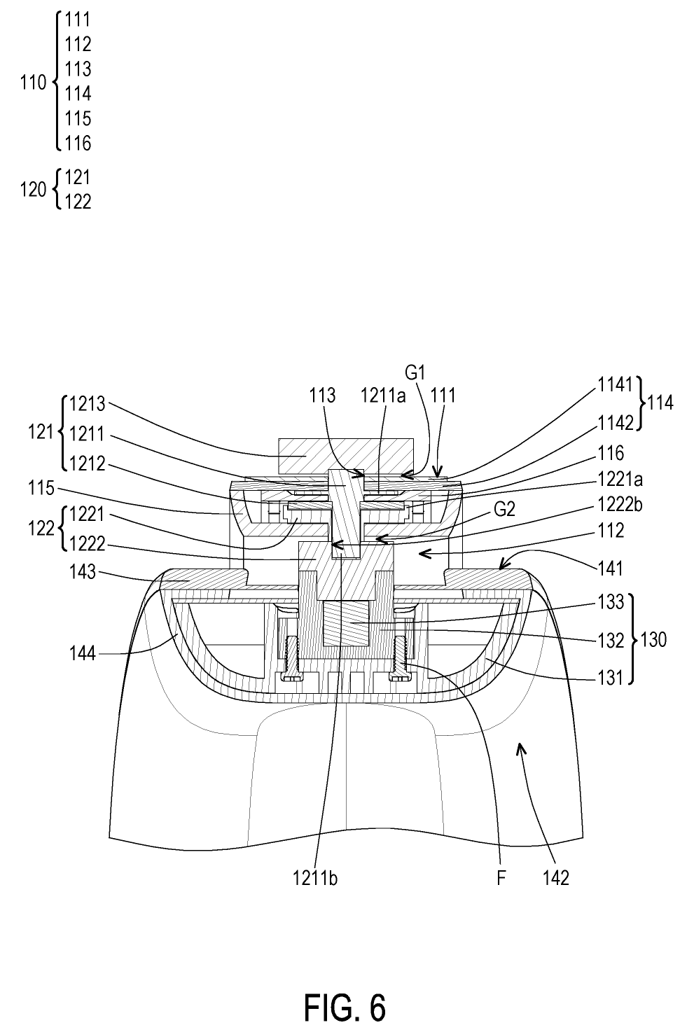

F FIG. 4 is an exploded view of the headband structure in FIG. 3. FIG. 5 is a cross- sectional view of the headband structure in FIG. 3. FIG. 6 is a cross-sectional view of the headband structure in FIG. 3 along a line B-B. Referring to FIGS. 2 and 4 -6, specifically, the upper headband 110 includes a first side 111 and a second side 112 opposite to each other and has two sliding slots 113 penetrating from the first side 111 to the second side 112. Each sliding structure 120 is slidably disposed inside a corresponding sliding slot 113. There is a first gap G1 between each sliding structure 120 and the first side 111, and there is a second gap G2 between each sliding structure 120 and the second side 112. The two fixing assemblies 130 are detachably connected to the corresponding two sliding structures 120 and located near the second side 112. The lower headband 140 includes a third side 141 and a fourth side 142 opposite to each other, the two fixing assemblies 130 are disposed on the third side 141, and the third side 141 is toward the second side 112. Part of the second side 112 of the upper headband 110 and the fourth side 142 of the lower headband 140 form a wearing segment. When the two sliding structures 120 slide with respect to the upper headband 110, a length L (shown in FIG. 2) of the wearing segment is changed.

It is worth mentioning that, since the sliding structure 120 of the headband structure 100 of this embodiment has the first gap G1 and the second gap G2 between the first side 111 and between the second side 112 of the upper headband 110 respectively, when the sliding structure 120 slides on the upper headband 110, the sliding structure 120 does not produce scratches on the surface of the upper headband 110, thereby ensuring that the headband structure 100 has a good appearance.

In addition, since the fixing assembly 130 of this embodiment is detachably connected to the sliding structure 120, accordingly, the user may conveniently replace a new lower headband 140 according to personal preference, or, when the headband structure 100 needs to be repaired, the user merely needs to replace the upper headband 110 or the lower headband 140, thereby saving costs.

In this embodiment, the dimensions of the first gap G1 and the second gap G2 are, for example, 0.2 millimeters (mm), but the disclosure does not limit the dimensions of the first gap G1 and the second gap G2.

The structure of the headband structure 100 of this embodiment will be described in detail below. Since the headband structure 100 is symmetrical from left to right as shown in FIG. 2, the following description will be based on the right side of the headband structure 100.

Referring to FIGS. 4 to 6, the upper headband 110 includes a first housing 114, a second housing 115, and two sliding covers 116. The first housing 114 is located at the first side 111. The second housing 115 is located at the second side 112. Each sliding cover 116 is connected to the first housing 114, located between the first housing 114 and the second housing 115, and corresponding to the sliding slot 113. Each sliding structure 120 includes an abutting assembly 121 and a connection assembly 122 connected to the abutting assembly 121. The abutting assembly 121 abuts against the connection assembly 122. The connection assembly 122 is slidably disposed on the second housing 115.

In this embodiment, the first housing 114 includes a metal housing 1141 and a plastic housing 1142, the plastic housing 1142 is located between the metal housing 1141 and the sliding cover 116. The material of the sliding cover 116 is plastic and is adapted to be fixed to the plastic housing 1142 by heat fusion. Accordingly, the upper headband 110 of this embodiment may have a thinner thickness and a shorter working time during assembly.

The structure of the abutting assembly 121 and the connection assembly 122 of this embodiment will be described in detail below.

FIG. 7 is a schematic view of an abutting member in FIG. 4. Referring to FIGS. 5 to 7, the abutting assembly 121 includes an abutting member 1211, a first fixing member 1212, and a decorative cover 1213. As shown in FIG. 6, a sliding portion 121la of the abutting member 1211 of the abutting assembly 121 may be slidably located between the first housing 114 and the corresponding sliding cover 116, and each sliding cover 116 is located between the sliding portion 121la and the first fixing member 1212. There is the first gap G1 between the decorative cover 1213 and the first side 111, which may prevent producing scratches on the upper headband 110 when the abutting assembly 121 slides, thereby ensuring that the headband structure 100 has a good appearance.

In this embodiment, the abutting member 1211 and the first fixing member 1212 are fixed to each other through a securing member F, but the disclosure does not limit the fixing method of the abutting member 1211 and the first fixing member 1212.

Referring to FIG. 4 to FIG. 6, the connection assembly 122 includes a second fixing member 1221 and a connection member 1222. The second fixing member 1221, as shown in FIG. 5, is located between the first fixing member 1212 of the abutting assembly 121 and the connection member 1222. The second housing 115, as shown in FIG. 6, is located between the second fixing member 1221 and the connection member 1222. The abutting member 1211 of the abutting assembly 121 is connected to the second fixing member 1221 and the connection member 1222. The abutting member 1211 of the abutting assembly 121 has an abutting portion 1211b, the connection member 1222 of the connection assembly 122 has a groove 1222b, and the abutting portion 1211b abuts against the groove 1222b. Accordingly, the headband structure 100 may abut the connection member 1222 through the abutting assembly 121 to ensure that there is the second gap G2 between the connection member 1222 and the second side 112, which may ensure that the connection member 1222 does not produce scratches on the second side 112 when sliding, thereby ensuring that the headband structure 100 has a good appearance.

In this embodiment, the second fixing member 1221 and the connection member 1222 are fixed to each other through the securing member F, but the disclosure does not limit the fixing method of the second fixing member 1221 and the connection member 1222.

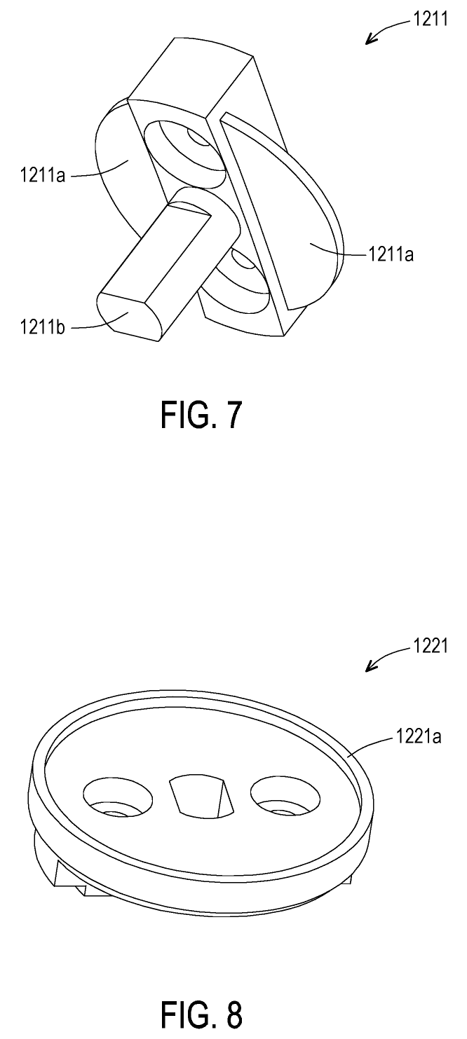

FIG. 8 is a schematic view of a second fixing member in FIG. 4. Referring to FIG. 5, FIGS. 6 and 8 the second fixing member 1221 further includes a stopper portion 1221a, and the stopper portion 1221a surrounds the first fixing member 1212 of the abutting assembly 121 as shown in FIG. 5, so that the abutting assembly 121 and the connection assembly 122 may be securely connected to each other.

The structure of the fixing assembly 130 of this embodiment will be described in detail below.

Referring to FIGS. 4 to 6, each fixing assembly 130 includes a fixing base 131 and a base body 132 disposed in the fixing base 131, the base body 132 of each fixing assembly 130 is detachably connected to the connection member 1222 of the corresponding connection assembly 122. In this embodiment, the base body 132 is fixed to the fixing base 131, for example, through the securing member F, but the disclosure does not limit the method by which the base body 132 is fixed to the fixing base 131.

Referring to FIGS. 4 to 6, each fixing assembly 130 further includes a magnetic member 133 disposed in the base body 132. The material of the connection member 1222 of the connection assembly 122 is metal. Accordingly, each sliding structure 120 is adapted to be securely connected to the base body 132 of the corresponding fixing assembly 130 by the magnetic attraction between the connection member 1222 and the magnetic member 133.

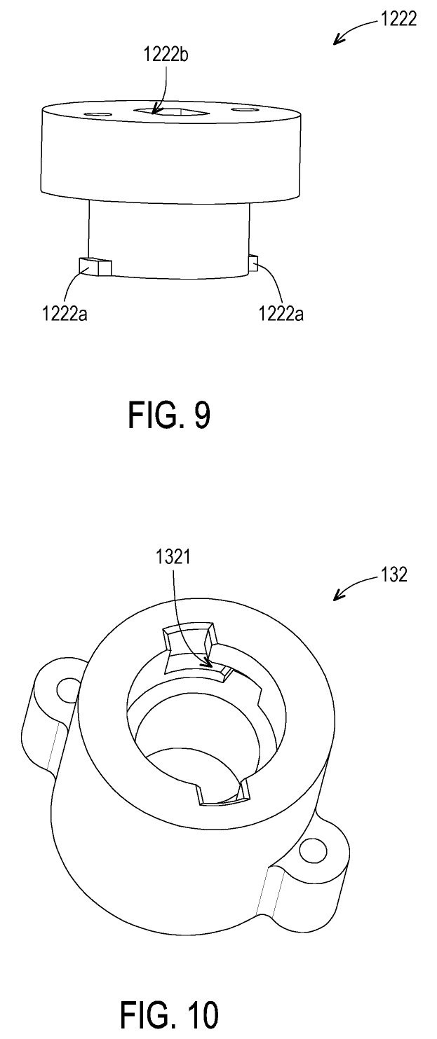

FIG. 9 is a schematic view of a connection member in FIG. 4. FIG. 10 is a schematic view of a base body in FIG. 4. Referring to FIGS. 5, 9 and 10, the base body 132 has at least one engagement groove 1321 (shown as two), and the connection member 1222 includes at least one positioning portion 1222a (shown as two). The positioning portion 1222a is adapted to reach into the corresponding engagement groove 1321, so that the connection member 1222 may be more securely connected to the base body 132.

The assembly steps of the headband structure 100 of this embodiment will be described in detail below.

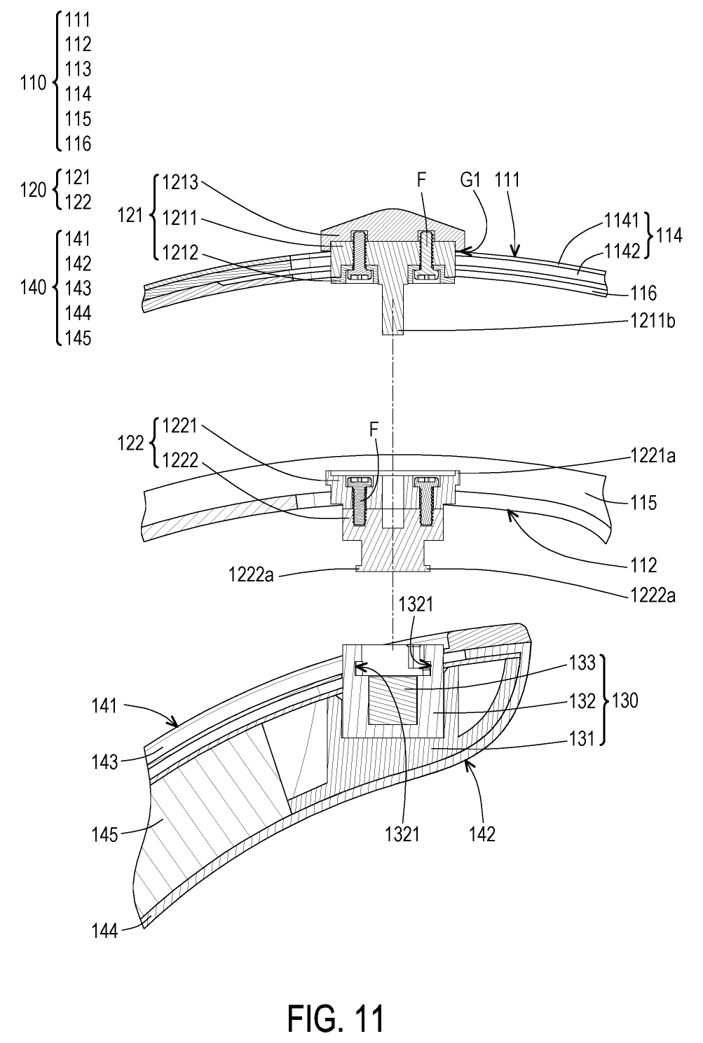

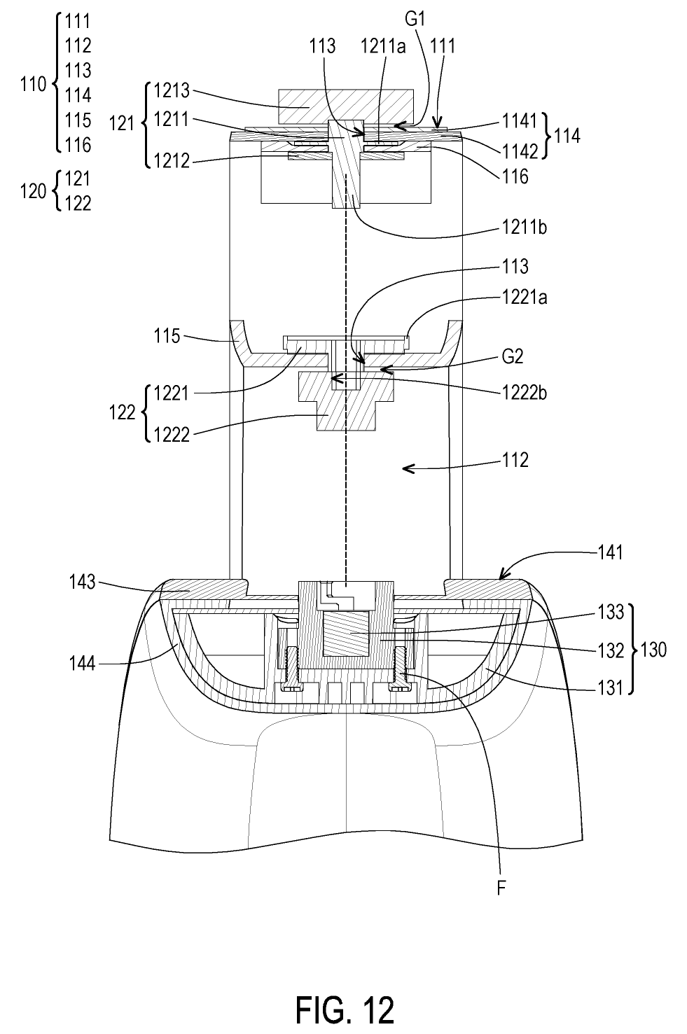

FIG. 11 illustrates an abutting assembly disposed in a first housing, a connection assembly disposed in a second housing, and a fixing assembly disposed in a lower headband in FIG. 5. FIG. 12 illustrates the abutting assembly disposed in the first housing, the connection assembly disposed in the second housing, and the fixing assembly disposed in the lower headband in FIG. 6. Referring to FIGS. 11 and 12, first, the abutting member 1211 of the abutting assembly 121 is disposed on the first housing 114, and the sliding cover 116 is fixed to the plastic housing 1142 of the first housing 114 by heat fusion, so that the sliding portion 121la of the abutting member 1211 is positioned between the first housing 114 and the sliding cover 116. Next, the first fixing member 1212 is installed and fixed to the abutting member 1211 with the securing member F, so that the sliding cover 116 is positioned between the abutting member 1211 and the first fixing member 1212. Next, the second fixing member 1221 is disposed on the second housing 115, and the connection member 1222 is fixed to the second fixing member 1221 through the securing member F, so that the second housing 115 is positioned between the connection member 1222 and the second fixing member 1221. Next, the first housing 114 and the abutting assembly 121 are assembled together with the connection assembly 122 and the second housing 115 in an up-and-down manner, and the assembly of the upper headband 110 with the abutting assembly 121 is completed.

Next, the fixing base 131 and the base body 132 are fixed with the securing member F. Next, after combining the fixing base 131 and an inner layer 145, the components are covered with an outer layer 144 and an elastic member 143. Next, the magnetic member 133 is fixed to the base body 132 by adhesive. Next, the fixing assembly 130 is connected with the sliding structure 120 through the magnetic member 133 in the base body 132 and the connection member 1222 made of metal. Finally, the fixing assembly 130 is rotated so that the positioning portion 1222a of the connection member 1222 is engaged with the engagement groove 1321 of the base body 132. The lower headband 140 is securely connected to the upper headband 110 through the sliding structure 120 and the fixing assembly 130.

In this embodiment, the material of the inner layer 145 may be, for example, Ethylene Vinyl Acetate (EVA), the material of the outer layer 144 may be, for example, Polyurethane (PU), and the material of the elastic member 143 may be, for example, Thermoplastic Elastomers (TPE), but the disclosure does not limit the materials of the inner layer 145, the outer layer 144, and the elastic member 143.

In summary, the headband structure of the disclosure includes the upper headband, the sliding structures, the fixing assemblies, and the lower headband. The sliding structure may slide with respect to the upper headband and the lower headband is connected to the upper headband through the sliding structure and the fixing assembly, so that the user may adjust the relative position of the upper headband and the lower headband through the sliding structure, thereby adjusting the wearing length of the headband structure. Since the sliding structure has the first gap and the second gap between the first side and between the second side of the upper headband respectively, when the sliding structure slides on the upper headband, the sliding structure does not produce scratches on the surface of the upper headband, thereby ensuring that the headband structure has a good appearance.

What is claimed is:

1. A headband structure, comprising:
an upper headband comprising a first side and a second side opposite to each other, and
having two sliding slots penetrating from the first side to the second side;two sliding structures slidably disposed inside the two sliding slots respectively, wherein each of the sliding structures has a first gap between the first side and has a second gap between the second side;two fixing assemblies detachably fixed to corresponding ones of the two sliding structures respectively, and located near the second side; anda lower headband comprising a third side and a fourth side opposite to each other, wherein the two fixing assemblies are disposed on the third side and the third side is toward the second side,wherein part of the second side of the upper headband and the fourth side of the lower headband form a wearing segment, and in response to the two sliding structures sliding with
respect to the upper headband, a length of the wearing segment is changed.

2. The headband structure as claimed in claim 1, wherein the upper headband comprises a first housing, a second housing, and two sliding covers, the first housing is located at the first side, the second housing is located at the second side, the two sliding covers are connected to the first housing, located between the first housing and the second housing, and corresponding to the two
sliding slots respectively, each of the sliding structures comprises an abutting assembly and a connection assembly, the abutting assembly abuts against the connection assembly, a portion of the abutting assembly is slidably located between the first housing and a corresponding one of the two sliding covers, and the connection assembly is slidably disposed on the second housing.

3. The headband structure as claimed in claim 2, wherein the abutting assembly comprises
an abutting member and a first fixing member connected to the abutting member, a sliding portion of the abutting member is slidably located between the first housing and a corresponding one of
the two sliding covers, and the two sliding covers are located between the sliding portion and the first fixing member.

4. The headband structure as claimed in claim 2, wherein the connection assembly comprises a second fixing member and a connection member, the second fixing member is located between
the abutting assembly and the connection member, the second housing is located between the second fixing member and the connection member, and the abutting assembly is connected to the second fixing member and the connection member.

5. The headband structure as claimed in claim 4, wherein there is a second gap between the connection member and the second side.

6. The headband structure as claimed in claim 4, wherein the second fixing member further comprises a stopper portion, and the stopper portion surrounds the abutting assembly.

7. The headband structure as claimed in claim 2, wherein each of the fixing assemblies comprises a fixing base and a base body disposed in the fixing base, and the two fixing assemblies are detachably connected to corresponding ones of the connection assemblies respectively.

8. The headband structure as claimed in claim 7, wherein each of the fixing assemblies further comprises a magnetic member disposed in the base body, a material of a connection member of the connection assembly is metal, the two sliding structures are adapted to be connected to corresponding ones of the two fixing assemblies through magnetic attraction between the connection member and the magnetic member.

9. The headband structure as claimed in claim 8, wherein the base body has at least one engagement groove, the connection member comprises at least one positioning portion, and the at least one positioning portion is adapted to reach into the at least one engagement groove, so that the connection member is connected to the base body.

10. The headband structure as claimed in claim 2, wherein the abutting assembly has an
abutting portion, the connection assembly has a groove, and the abutting portion abuts against the groove.

11. The headband structure as claimed in claim 2, wherein the first housing comprises a metal housing and a plastic housing, the plastic housing is located between the metal housing and the sliding cover, and a material of the sliding cover is plastic and is adapted to be fixed to the plastic housing by heat fusion.

12. The headband structure as claimed in claim 2, wherein the abutting assembly comprises a decorative cover, and there is the first gap between the decorative cover and the first side.
